(19) United States
(12) Patent Application Publication
(10) Pub. No.: US 2013/0232361 A1
(43) Pub. Date: Sep. 5, 2013

(54) INFORMATION PROCESSING APPARATUS AND INFORMATION PROCESSING METHOD

(71) Applicant: CANON KABUSHIKI KAISHA, Tokyo (JP)

(72) Inventor: Yuichi Nishii, Kawasaki-shi (JP)

(21) Appl. No.: 13/778,756

(22) Filed: Feb. 27, 2013

(30) Foreign Application Priority Data
Mar. 1, 2012 (JP) 2012-045423

(51) Int. Cl. G06F 1/32

(52) U.S. Cl. CPC G06F 1/3234
USPC 713/323

(57) ABSTRACT

When a predetermined time elapses after the start of a screen saver, it is detected whether or not an apparatus is driven by a battery. For AC driving, the apparatus is shifted to a sleep state for power saving, since there is a low power-off risk. For battery driving, it is discriminated whether or not the battery has a sufficient remaining battery level, and the apparatus is shifted to a rest state for avoiding the power-off risk, when the battery has a low remaining battery level. When the remaining battery level is sufficient, the apparatus is shifted to the sleep state and then to the rest state after a first predetermined time, if inspection information is absent, whereas the apparatus is shifted to the sleep state and then to the rest state after a second, longer predetermined time, if the inspection information is present.

### BACKGROUND OF THE INVENTION

1. Field of the Invention

The present invention relates to an information processing apparatus which is used in an X-ray radiographing system and can be driven by a battery, and a control method and a program for such an information processing apparatus.

2. Description of the Related Art

In the related arts, a requirement to realize a high efficiency and a high speed of an inspection by converting medical image information of a patient which is generated in a hospital into digital data and by storing and transmitting the digital data has been increasing. Therefore, even in the field of the X-ray radiographing, a digital system for outputting digital data by using an X-ray detector such as an FPD (Flat Panel Detector) or the like has widely been used in place of a screen/film system so far. The number of cases where a radio communicating function is provided for the X-ray detector is also increasing.

An all-wireless system in which radio communication is performed by using a PC (personal computer) such as a tablet PC or the like which can be driven by a battery together with the X-ray detector having such a radio communicating function has been constructed.

In the battery-drivable PC, since the PC is driven by the battery, power saving is important. In order to cope with the power saving, in a desk-top PC in the related art, it is a general way to shift the system into a sleep (standby) state after a predetermined time by using a management of a power source which is provided by the OS. In a mobile PC such as a tablet PC or the like, if the sleep state is used, data is stored only in a memory. There is, consequently, such a problem that the data is lost when the battery is dead. Generally, the system is operated in such a manner that when a predetermined time elapses after the sleep, the system is shifted to a rest state (generally called “hibernation”) in which the data is stored in an HDD.

As a prior art, for example, Japanese Patent Application Laid-Open No. 2007-264953 discloses such a construction that in an information processing apparatus having a receiving apparatus for receiving broadcasting program data although it is not an X-ray radiographing system, the apparatus is shifted from an operation state to a first sleep state in which power consumption is smaller than that in the operation state and to a second sleep state in which power consumption is smaller than that in the first sleep state and a time which is required for recovery to the operation state is longer than that in the first sleep state. It also discloses such a construction that when a TV application program for reproducing broadcasting program data which is received by a TV tuner is activated, a shift to the second sleep state is inhibited.

The operating method of the mobile PC mentioned above has such a problem that when the apparatus is shifted into hibernation, an activating time is delayed. In the mobile PC operation, shorter activating time, as well as the power saving, is an important subject.

The invention is made in consideration of the problems as mentioned above and it is an object of the invention to provide an information processing apparatus which is used in an X-ray radiographing system and can be driven by a battery, wherein an power saving and a high-speed activation can be realized.

### SUMMARY OF THE INVENTION

In order to solve the above problem, the present invention provides an information processing apparatus for use in an X-ray radiographing system, comprising a detection unit that detects whether the information processing apparatus is driven by a battery or by an external power source, a discrimination unit that discriminates whether inspection information of the X-ray radiographing system is present or absent, and a shifting unit that shifts the information processing apparatus to a power saving mode on the basis of the detection by the detection unit and the discrimination by the discrimination unit.

Further features of the present invention will become apparent from the following description of exemplary embodiments with reference to the attached drawings.

### BRIEF DESCRIPTION OF THE DRAWINGS

FIG. 1 is a block diagram illustrating a construction of an information processing apparatus which is used in an X-ray radiographing system according to the first embodiment.

FIG. 2 is a flowchart showing the processing operation of the information processing apparatus according to the first embodiment.

FIG. 3 is a flowchart showing the processing operation of an information processing apparatus according to the second embodiment.

### DESCRIPTION OF THE EMBODIMENTS

Exemplary embodiments of the invention will be described hereinbelow with reference to the drawings.

### First Embodiment

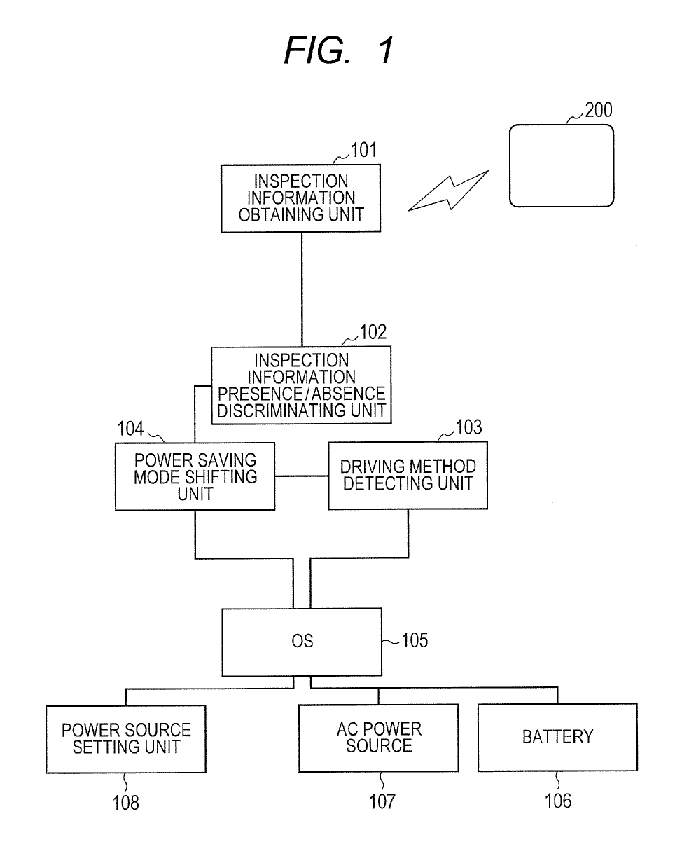

FIG. 1 is a block diagram illustrating a construction of an information processing apparatus which is used in an X-ray radiographing system according to the embodiment. The information processing apparatus is constructed by a PC (personal computer) such as a tablet PC or the like which can be driven by an AC power source and a battery.

An inspection information obtaining unit 101 obtains inspection information of an inspection which is scheduled to be executed by an X-ray detector 200 such as an FPD (Flat Panel Detector) or the like constructing the X-ray radiographing system from an external inspection instructing apparatus as digital data by, for example, the radio communicating function. The inspection information is, for example, information in which an inspection such as chest radiographing, abdominal radiographing, or the like which is scheduled to be executed is managed every patient. An inspection information presence/absence discriminating unit 102 detects the presence or absence of the inspection information obtained by the inspection information obtaining unit 101. For example, the presence or absence of the inspection information is discriminated on the basis of whether or not there is a pending inspection or an inspection which is not executed yet or whether or not the inspection is being executed.

A driving method detecting unit 103 detects, through an OS (Operating System) unit 105, whether the apparatus is driven by a battery 106 or by an AC power source 107.

A power saving mode shifting unit 104 issues an instruction of a power saving mode to a power source setting unit 108 via the OS unit 105 on the basis of detection information from the inspection information presence/absence discriminating unit 102 and the driving method detecting unit 103, thereby shifting the apparatus to the power saving mode.

The OS unit 105 provides fundamental functions and controls and manages the whole computer system. The battery 106 supplies power to the apparatus by itself, and the AC power source 107 supplies power to the apparatus via an external source. The power source setting unit 108 sets which one of the battery 106 and the AC power source 107 is used as a power source.

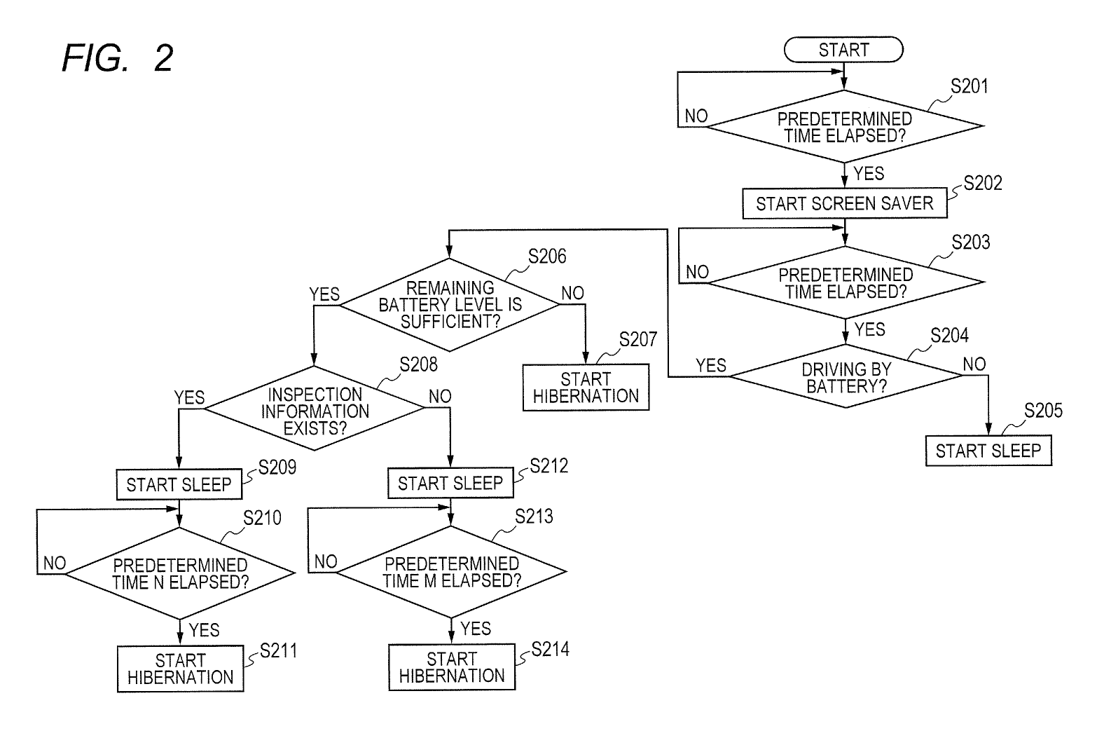

FIG. 2 illustrates the processing operation of the information processing apparatus according to the embodiment. When no operation is executed in the information processing apparatus and a predetermined time elapses (step S201), a screen saver is started (step S202). During the serving of the screen saver, the inspection information can be obtained by the inspection information obtaining unit 101.

When a predetermined time elapses after the start of the screen saver (step S203), it is discriminated by the driving method detecting unit 103 whether or not the apparatus is driven by the battery (step S204). If the apparatus is driven by the AC power source, since there is a low risk of power off, the apparatus is shifted to a sleep state (a first power saving mode) by the power saving mode shifting unit 104 (step S205). In the sleep state, data is stored in the memory and therefore high-speed activation can be performed.

If the apparatus is driven by the battery (step S204), it is discriminated whether or not the battery 106 has a sufficient remaining battery level (step S206). If it is determined that the battery 106 has a low remaining battery level (that is, the remaining battery level is equal to or less than a predetermined threshold value), the apparatus is shifted to a rest state (a second power saving mode) by the power saving mode shifting unit 104, since there is a high risk of power off (step S207). The rest state will be hereafter called “hibernation”. Although it requires a longer time for activation than the sleep state, the hibernation is a safe measure since the data is stored in the hard disk, and also the hibernation leads to a great power saving effect as compared to the sleep state.

If it is determined in step S206 that the battery 106 has a sufficient remaining battery level (that is, the remaining battery level exceeds the predetermined threshold value), the presence or absence of the inspection information is discriminated by the inspection information presence/absence discriminating unit 102 (step S208). The presence or absence of the inspection information is discriminated on the basis of whether or not there is a pending inspection or an unexecuted inspection or whether or not the inspection is being executed (step S208).

If it is determined in step S208 that the inspection information is absent, the apparatus is shifted to the sleep state by the power saving mode shifting unit 104 (step S212). After the elapse of a predetermined time M (step S213), the apparatus is then shifted to the hibernation (step S214). If it is determined in step S208 that the inspection information is present, the apparatus is shifted to the sleep state by the power saving mode shifting unit 104 (step S209). After the elapse of a predetermined time N (step S210), the apparatus is then shifted to the hibernation (step S211).

It is assumed that the predetermined time N (where the inspection information is present) is longer than the predetermined time M (where the inspection information is absent). This is because (a) if the inspection information is present, there is a very high possibility that the inspection will be restarted and it is therefore desirable that the apparatus waits in the sleep mode as long as possible such that the apparatus may be immediately returned to the original state, and (b) if the inspection information is absent, there is little possibility that the inspection will be executed and it is therefore desirable to quickly shift the apparatus to the hibernation, which is safe and leads to a greater power saving effect, although it requires a longer activation time. It is also assumed that if the operation by an interface such as mouse, keyboard, or the like is executed in the present sequence, the operation is immediately returned to “start”.

### Second Embodiment

Next, the second embodiment will be described. Since the construction of an information processing apparatus which is used in the X-ray radiographing system in this embodiment is similar to that in the first embodiment, its description is omitted here.

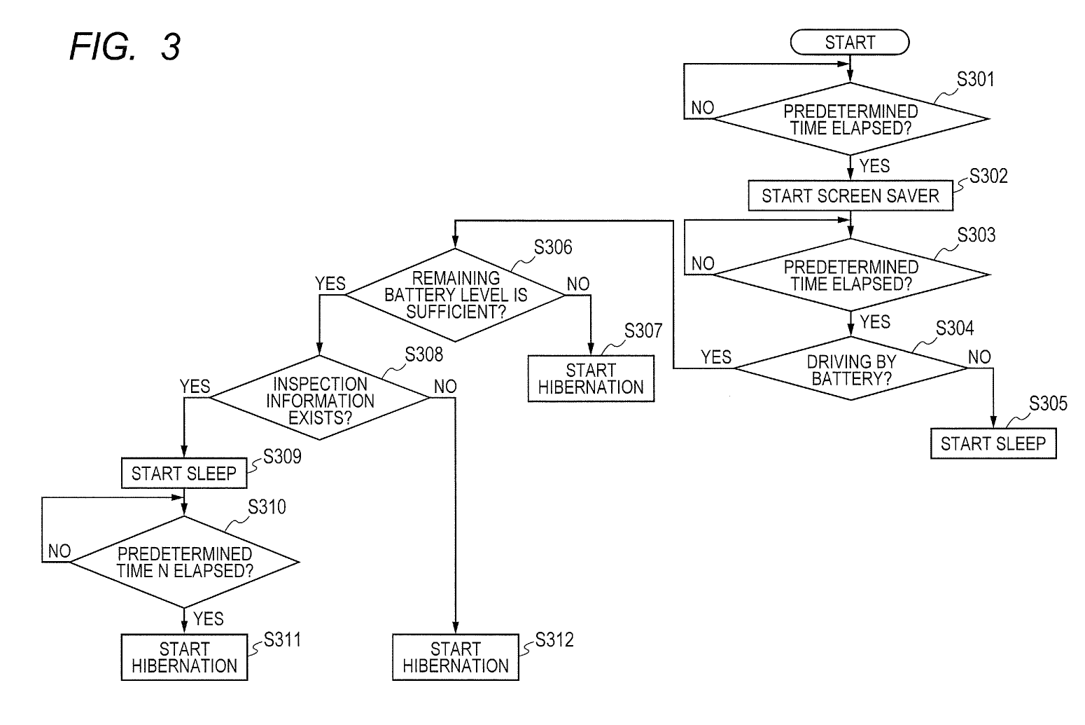

FIG. 3 illustrates the processing operation of the information processing apparatus according to the second embodiment. Steps S301 to S311 are identical to steps S201 to S211 in FIG. 2, respectively. The second embodiment differs from the first embodiment only in that if it is determined in step S308 that the inspection information is absent, the apparatus is directly shifted to the hibernation without shifting to the sleep state (step S314). In other words, the predetermined time M is set to zero (M=0) in the flowchart of FIG. 2.

### Other Embodiments

Embodiments of the present invention can also be realized by a computer of a system or apparatus that reads out and executes computer-executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer-executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-045423, filed Mar. 1, 2012, which is hereby incorporated by reference herein in its entirety.

What is claimed is:

1. An information processing apparatus for use in an X-ray radiographing system, comprising:
a detection unit configured to detect whether the information processing apparatus is driven by a battery or by an external power source;
a discrimination unit configured to discriminate whether inspection information of the X-ray radiographing system is present or absent; and
a shifting unit configured to shift the information processing apparatus to a power saving mode on the basis of the detection by the detection unit and the discrimination by the discrimination unit.

2. The information processing apparatus according to claim 1, wherein the shifting unit shifts the information processing apparatus to a first power saving mode or a second power saving mode on the basis of the detection by the detection unit and the discrimination by the discrimination unit.

3. The information processing apparatus according to claim 2, wherein the shifting unit shifts the information processing apparatus to the first power saving mode, when the detection unit detects that the information processing apparatus is driven by the external power source.

4. The information processing apparatus according to claim 2, wherein the shifting unit shifts the information processing apparatus to the second power saving mode, when the detection unit detects that the information processing apparatus is driven by the battery and when the battery has a low remaining battery level.

5. The information processing apparatus according to claim 2, wherein the shifting unit shifts the information processing apparatus to the first power saving mode, and then to the second power saving mode after a first predetermined time, if the discrimination unit discriminates that the inspection information is absent, and wherein the shifting unit shifts the information processing apparatus to the first power saving mode, and then to the second power saving mode after a second predetermined time longer than the first predetermined time, if the discrimination unit discriminates that the inspection information is present.

6. The information processing apparatus according to claim 2, wherein the shifting unit shifts the information processing apparatus to the second power saving mode, if the discrimination unit discriminates that the inspection information is absent, and wherein the shifting unit shifts the information processing apparatus to the first power saving mode, and then to the second power saving mode, if the discrimination unit discriminates that the inspection information is present.

7. The information processing apparatus according to claim 5, wherein the shifting unit shifts the information processing apparatus to the first or second power saving mode on the basis of the discrimination by the discrimination unit, when the detection unit detects that the information processing apparatus is driven by the battery and when the battery has a sufficient remaining battery level.

8. The information processing apparatus according to claim 2, wherein the first power saving mode is realized by a sleep state where data is stored in a memory, and the second power saving mode is realized by a rest state where data is stored in a hard disk.

9. A method of controlling an information processing apparatus for use in an X-ray radiographing system, the method comprising:
detecting whether the information processing apparatus is driven by a battery or by an external power source;
discriminating whether inspection information of the X-ray radiographing system is present or absent; and
shifting the information processing apparatus to a power saving mode on the basis of a detection in the detecting and a discrimination in the discriminating.

10. A non-transitory computer-readable storage medium storing a computer program that causes a computer to execute the method according to claim 9.
